(19) United States
(12) Patent Application Publication
(10) Pub. No.: US 2011/0318661 A1
(43) Pub. Date: Dec. 29, 2011

(54) MEMBRANE ELECTRODE UNITS

(75) Inventors: Oemer Uensal, Mainz (DE); Sigmar Bräuninger, Hemsbach (DE); Werner Urban, Mannheim (DE); Jennifer Dahl, Ludwigshafen (DE); Lucas Montag, Burstadt (DE); Stefan Herzog, Lambrecht (DE)

(73) Assignee: BASF SE, Ludwigshafen (DE)

(21) Appl. No.: 13/254,525

(22) PCT Filed: Mar. 3, 2010
(86) PCT No.: PCT/EP2010/001315

§ 371 Date: Sep. 2, 2011

(30) Foreign Application Priority Data
Mar. 6, 2009 (EP) 09003257.4

(51) Int. Cl. H01M 8/10; B05D 5/12; B05D 3/02; H01M 8/04

(52) U.S. Cl. 429/428; 429/480; 427/58

(57) ABSTRACT

A membrane electrode assembly, comprising at least one phosphoric acid-containing polymer electrolyte membrane and at least one gas diffusion electrode, said gas diffusion electrode comprising:
i. at least one catalyst layer and
ii. at least one gas diffusion medium having at least two gas diffusion layers,
   the first gas diffusion layer comprising an electrically conductive macroporous layer in which the pores have a mean pore diameter in the range from 10 μm to 30 μm,
   the second gas diffusion layer comprising an electrically conductive macroporous layer in which the pores have a mean pore diameter in the range from 10 μm to 30 μm,
   the gas diffusion medium comprising polytetrafluoroethylene,
   the first gas diffusion layer having a higher polytetrafluoroethylene concentration than the second gas diffusion layer.

The present invention relates to improved membrane electrode assemblies, having two electrochemically active electrodes separated by a polymer electrolyte membrane.

In polymer electrolyte membrane (PEM) fuel cells, the proton-conducting membranes used nowadays are almost exclusively sulfonic acid-modified polymers. Predominantly perfluorinated polymers are employed. A prominent example thereof is Nafion® from DuPont de Nemours, Wilmington, USA. For proton conduction, a relatively high water content in the membrane is required, which is typically 4-20 molecules of water per sulfonic acid group. The water content needed, but also the stability of the polymer in conjunction with acidic water and the hydrogen and oxygen reaction gases, limits the operating temperature of the PEM fuel cell stacks to 80-100° C. Higher operating temperatures cannot be achieved without loss of performance of the fuel cell. At temperatures above the dew point of water for a given pressure level, the membrane dries out completely, and the fuel cell no longer supplies any electrical energy since the resistance of the membrane rises to such high values that there is no longer any significant current flow.

For system-related reasons, however, higher operating temperatures than 100° C. in the fuel cell are desirable. The activity of the noble-metal-based catalysts present in the membrane electrode assembly (MEA) is much better at high operating temperatures.

More particularly, in the case of use of what are called reformates from hydrocarbons, distinct amounts of carbon monoxide are present in the reformer gas and typically have to be removed by a costly and inconvenient gas processing or gas cleaning operation. At high operating temperatures, the tolerance of the catalysts to the CO impurities rises.

In addition, heat arises in the operation of fuel cells. However, cooling of these systems to below 80° C. can be very costly and inconvenient. According to the power released, the cooling apparatus can be made much simpler. This means that, in fuel cell systems which are operated at temperatures above 100° C., the waste heat can be utilized much better and hence the fuel cell system efficiency can be enhanced.

In order to attain these temperatures, membranes with novel conductivity mechanisms are generally used, especially membranes based on polyazoles. Such membranes are described in detail, for example, in DE 10 2005 038195.

This publication also explains the production of membrane electrode assemblies which can be used in fuel cells. The membrane electrode assemblies should have two gas diffusion layers, each of which is in contact with a catalyst layer, and which are separated by the polymer electrolyte membrane.

The gas diffusion layers used in this context are flat, electrically conductive and acid-resistant structures, for example graphite fiber papers, carbon fiber papers, graphite fabrics and/or papers which have been rendered conductive by addition of carbon black.

The catalyst layers should comprise catalytically active substances, for example noble metals of the platinum group, i.e. Pt, Pd, Ir, Rh, Os, Ru, or else the noble metals Au and Ag. The metals can optionally be used on a support material, for example carbon, especially in the form of carbon black, graphite or graphitized carbon black. It is additionally possible that the catalytically active layers comprise further additives, for example fluoropolymers, especially polytetrafluoroethylene (PTFE), proton-conducting ionomers and surface-active substances.

Such electrodes are produced typically using a catalyst ink, which comprises a noble metal catalyst, for example platinum, on a support material, for example carbon black, a binder and hydrophobizing agent, for example PTFE, a surfactant and a thickener, for example methylcellulose. However, the electrode catalyst used is usually acidic, and so the catalyst ink with the components mentioned has an acidic pH. As a result of this, PTFE flocculates out of the composition since the PTFE particles can be stabilized only under alkaline conditions.

After the production, the surfactant is decomposed by sintering at relatively high temperatures, usually greater than 300° C., and the binder is heat treated. However, these high temperatures are proven to detract from the catalyst activity. Moreover, the thermal treatment can lead to oxidation of the support material, which can in turn significantly impair the performance and lifetime of the electrode.

The publication X. L. Wang et al. Micro-porous layer with composite carbon black for PEM fuel cells Electrochimica Acta 51 (2006) 4909-4915 discloses gas diffusion layers for fuel cells which comprise a macroporous gas diffusion layer composed of carbon fiber paper or graphite fabric and a microporous layer.

The microporous layer is obtained by applying carbon black and a hydrophobizing agent to the upper and lower side of the macroporous gas diffusion layer. The task of the microporous layer is supposed to be to provide the correct pore structure and hydrophobicity in order to bring a catalyst layer to the membrane-facing side and to enable better gas transport and better removal of water from the catalyst layer, and to reduce the electrical contact resistance to the catalyst layer.

The gas diffusion layers are tested using a Nafion® membrane at 80° C., which has been coated on the upper and lower sides with a homogeneous perfluoropolymer (PF)/C mixture. However, due to the small pores on the reverse side of the gas diffusion layer, such systems at operating temperatures above 100° C. lead to problems and to a decrease in performance. For instance, more particularly, the permeability to air at 200 Pa according to test standard EN ISO9237 is less than 5 l/m²s.

It was therefore an object of the present invention to provide an improved MEA and fuel cells operated therewith, which should preferably have the following properties:
The cells in the case of operation at temperatures above 100° C. should exhibit a long lifetime.
The individual cells should exhibit constant or improved performance at temperatures above 100° C. over a long period.
At the same time, the fuel cells should have, after long operating time, a high zero-load voltage and low gas crossover.
The fuel cells should be usable especially at operating temperatures above 100° C. and not need any additional fuel gas moistening. More particularly, the membrane electrode assemblies should be able to withstand permanent or changing pressure differences between anode and cathode.
In addition, it was therefore an object of the present invention to provide a membrane electrode assembly which can be produced in a simple and inexpensive manner. At the same time, more particularly, a minimum amount of expensive materials was to be used.
More particularly, the fuel cell even after a long time should have a high voltage and be operable at low stoichiometry.
More particularly, the MEA should be robust to different operating conditions (T, p, geometry, etc.) in order to increase general reliability.
Furthermore, expensive noble metal, especially platinum metals, should be exploited very effectively.

In addition, means for very simple, very inexpensive and very effective production of such MEAs were to be indicated.

These objects are achieved by membrane electrode assemblies having all the features of claim 1. In addition, a particularly advantageous process for production of such membrane electrode assemblies and particularly appropriate applications are protected.

The present invention accordingly provides a membrane electrode assembly, comprising at least one phosphoric acid-containing polymer electrolyte membrane and at least one gas diffusion electrode, said gas diffusion electrode comprising:

i. at least one catalyst layer and

ii. at least one gas diffusion medium having at least two gas diffusion layers,
the first gas diffusion layer comprising an electrically conductive macroporous layer in which the pores have a mean pore diameter in the range from 10 μm to 30 μm,
the second gas diffusion layer comprising an electrically conductive macroporous layer in which the pores have a mean pore diameter in the range from 10 μm to 30 μm,
the gas diffusion medium comprising polytetrafluoroethylene, the first gas diffusion layer having a higher polytetrafluoroethylene concentration than the second gas diffusion layer.

### Polymer Electrolyte Membranes

Polymer electrolyte membranes suitable for the purposes of the present invention are known per se and are described especially in U.S. Pat. No. 5,525,436, DE-A-101 17 687, DE-A-101 10 752, DE-A-103 31 365, DE-A-100 52 242, US 2008160378, US 2008233435, DE-U-20217178 and Handbook of Fuel Cells—Fundamentals and Technology and Applications, Vol. 3, Chapter 3, High temperature membranes, J. S. Wainright, M. H. Litt and R. F. Savinell.

According to the invention, polymer electrolyte membranes comprising phosphoric acid are used.

The membranes can be produced by methods including swelling of flat materials, for example of a polymer film, with a liquid comprising phosphoric acid or phosphoric acid-releasing compounds, or by production of a mixture of polymers and phosphoric acid-containing or phosphoric acid-releasing compounds and subsequent formation of a membrane by forming a flat article and then solidifying, in order to form a membrane.

Polymers suitable for this purpose include polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyhexafluoropropylene, copolymers of PTFE with hexafluoropropylene, with perfluoropropyl vinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, especially those of norbornene;

polymers having C—O bonds in the backbone, for example polyacetal, polyoxymethylene, polyethers, polypropylene oxide, polyepichlorohydrin, polytetrahydrofuran, polyphenylene oxide, polyether ketone, polyesters, especially polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;

polymers having C—S bonds in the backbone, for example polysulfide ethers, polyphenylene sulfide, polysulfones, polyether sulfone;

polymers having C—N bonds in the backbone, for example polyimines, polyisocyanides, polyetherimine, polyetherimides, polyaniline, polyaramids, polyamides, polyhydrazides, polyurethanes, polyimides, polyazoles, polyazole ether ketone, polyazines;

liquid-crystalline polymers, especially Vectra, and inorganic polymers, for example polysilanes, polycarbosilanes, polysiloxanes, polysilicic acid, polysilicates, silicones, polyphosphazenes and polythiazyl.

Preference is given to basic polymers. More particularly, virtually all known polymer membranes in which the protons can be transported are useful. Preference is given here to acids which can convey protons without additional water, for example by means of what is called the Grotthus mechanism.

The basic polymer used in the context of the present invention is preferably a basic polymer having at least a nitrogen atom in a repeat unit.

The repeat unit in the basic polymer comprises, in a preferred embodiment, an aromatic ring having at least one nitrogen atom. The aromatic ring is preferably a five- or six-membered ring having one to three nitrogen atoms, which may be fused to another ring, especially another aromatic ring.

In a particular aspect of the present invention, polymers of high thermal stability which comprise at least one nitrogen, oxygen and/or sulfur atom in one repeat unit or in different repeat units are used.

A polymer having “high thermal stability” in the context of the present invention is one which can be operated for a prolonged period as a polymeric electrolyte in a fuel cell at temperatures above 120° C. “For a prolonged period” means that an inventive membrane can be operated for at least 100 hours, preferably at least 500 hours, at least 110° C., preferably at least 120° C., more preferably at least 160° C., without any decrease in the performance, which can be measured by the method described in WO 01/18894 A2, by more than 50%, based on the starting performance.

The aforementioned polymers can be used individually or as a mixture (blend). Preference is given here especially to blends which comprise polyazoles and/or polysulfones. The preferred blend components are polyether sulfone, polyether ketone and polymers modified with sulfonic acid groups as described in German patent applications DE-A-100 52 242 and DE-A-102 45 451. The use of blends can improve the mechanical properties and reduce the material costs.

A particularly preferred group of basic polymers is that of polyazoles. A basic polymer based on polyazole comprises repeat azole units of the general formula (I) and/or (II) and/or (III) and/or (IV)

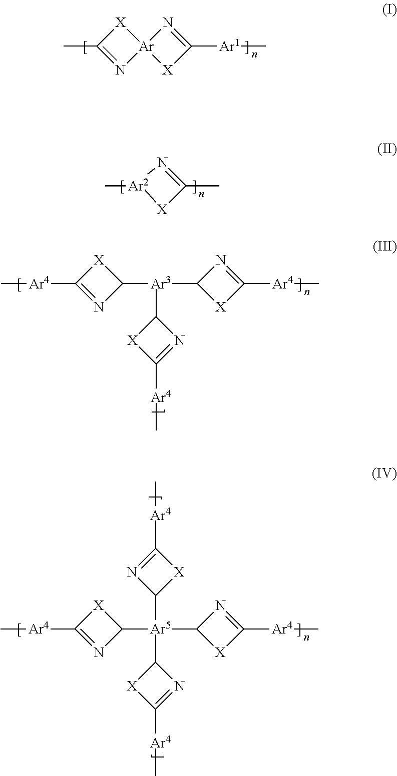

in which
Ar is the same or different and is a tetravalent aromatic or heteroaromatic group, which may be mono- or polycyclic,
Ar¹ is the same or different and is a divalent aromatic or heteroaromatic group, which may be mono- or polycyclic,
Ar² is the same or different and is a di- or trivalent aromatic or heteroaromatic group, which may be mono- or polycyclic,
Ar³ is the same or different and is a trivalent aromatic or heteroaromatic group, which may be mono- or polycyclic,
Ar⁴ is the same or different and is a trivalent aromatic or heteroaromatic group, which may be mono- or polycyclic,
Ar⁵ is the same or different and is a tetravalent aromatic or heteroaromatic group, which may be mono- or polycyclic,
X is the same or different and is oxygen, sulfur or an amino group, which bears a hydrogen atom, a group having 1 to 20 carbon atoms, preferably a branched or unbranched alkyl or alkoxy group, or an aryl group as a further radical
n is an integer greater than or equal to 10, preferably greater than or equal to 100.

Preferred aromatic or heteroaromatic groups derive from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may optionally also be substituted.

Preference is given to polyazoles with repeat units of the formula (I), in which the X radicals are the same within one repeat unit.

The polyazoles may in principle also have different repeat units which differ, for example, in the X radical thereof. Preferably, however, it only has identical X radicals in one repeat unit.

Further preferred polyazole polymers are polyimidazoles, polybenzthiazoles, polybenzoxazoles, polyoxadiazoles, polyquinoxalines, polythiadiazoles poly(pyridines), poly(pyrimidines), and poly(tetrazapyrenes).

In a particularly preferred embodiment of the present invention, the polymer comprising repeat azole units is a polyazole, which comprises only units of the formula (I) and/or (II).

The number of repeat azole units in the polymer is preferably an integer greater than or equal to 10. Particularly preferred polymers comprise at least 100 repeat azole units.

The polyazoles used, but especially the polybenzimidazoles, are notable for a high molecular weight. Measured as the intrinsic viscosity, it is at least 0.2 dl/g, preferably 0.8 to 10 dl/g, especially 1 to 10 dl/g.

The preparation of such polyazoles is known and described in DE-A-101 17 687, one or more aromatic tetramino compounds being reacted with one or more aromatic carboxylic acids or esters thereof which comprise at least two acid groups per carboxylic acid monomer in the melt to give a prepolymer. The resulting prepolymer solidifies in the reactor and is then mechanically comminuted. The pulverulent prepolymer is typically finally polymerized in a solid phase polymerization at temperatures of up to 400° C.

For production of polymer films, a polymer, preferably a polyazole, can be dissolved in a further step in polar aprotic solvents, for example dimethylacetamide (DMAc), and a film can be produced by means of conventional processes.

To remove solvent residues, the film thus obtained can be treated with a wash liquid, as described in German patent application DE-A-101 09 829. The cleaning of the polyazole film to remove solvent residues, described in German patent application, surprisingly improves the mechanical properties of the film. These properties include especially the modulus of elasticity, the breaking strength and the fracture toughness of the film.

In addition, the polymer film may have further modifications, for example, by crosslinking, as described in German patent application DE-A-101 10 752 or in WO 00/44816. In a preferred embodiment, the polymer film used, composed of a basic polymer and at least one blend component, additionally comprises a crosslinker, as described in German patent application DE-A-101 40 147.

The thickness of the polyazole films may be within wide ranges. The thickness of the polyazole film before doping with acid is preferably in the range from 5 μm to 2000 μm, more preferably in the range from 10 μm to 1000 μm, without any intention that this should impose a restriction.

In order to achieve proton conductivity, these films are doped with a phosphoric acid.

In addition, it is also possible to use polyphosphoric acids, which are then at least partly hydrolyzed.

The degree of doping can be used to influence the conductivity of the polyazole membrane. The conductivity increases with rising concentration of dopant until a maximum value is attained. According to the invention, the degree of doping is reported as moles of acid per mole of repeat unit of the polymer. In the context of the present invention, preference is given to a degree of doping between 3 and 50, especially between 5 and 40.

In general, highly concentrated acids are used. In a particular aspect of the present invention, the concentration of the phosphoric acid is at least 50% by weight, especially at least 80% by weight, based on the weight of the dopant.

In addition, it is also possible to obtain proton-conductive membranes by a process comprising the steps of
I) dissolving polymers, especially polyazoles in polyphosphoric acid,
II) heating the solution obtainable in step A) under inert gas to temperatures of up to 400° C.,
III) forming a membrane using the solution of the polymer according to step II) on a support and
IV) treating the membrane formed in step III) until it is self-supporting.

In addition, doped polyazole films can be obtained by a process comprising the steps of
A) mixing one or more aromatic tetramino compounds with one or more aromatic carboxylic acids or esters thereof which comprise at least two acid groups per carboxylic acid monomer, or mixing one or more aromatic and/or heteroaromatic diaminocarboxylic acids, in polyphosphoric acid to form a solution and/or dispersion
B) applying a layer using the mixture according to step A) on a support or on an electrode,
C) heating the flat structure/layer obtainable according to step B) under inert gas to temperatures of up to 350° C., preferably up to 280° C., to form the polyazole polymer,
D) treating the membrane formed in step C) (until it is self-supporting).

The aromatic or heteroaromatic carboxylic acid and tetramino compounds to be used in step A) have been described above.

The polyphosphoric acid used in step A) comprises commercial polyphosphoric acids, as obtainable, for example, from Riedel-de Haen. The polyphosphoric acids Hₙ₊₂PₙO₃ₙ₊₁ (n>1) typically have a content, calculated as P₂O₅ (by acidimetric means), of at least 83%. Instead of a solution of the monomers, it is also possible to produce a dispersion/suspension.

The mixture obtained in step A) has a weight ratio of polyphosphoric acid to sum of all monomers of 1:10 000 to 10 000:1, preferably 1:1000 to 1000:1, especially 1:100 to 100:1.

The layer formation in step B) is effected by means of measures known per se (casting, spraying, knife-coating) which are known from the prior art for polymer film production. Suitable supports are all supports which can be described as inert under the conditions. To adjust the viscosity, the solution can optionally be admixed with phosphoric acid (conc. phosphoric acid, 85%). This can adjust the viscosity to the desired value and facilitate the formation of the membrane.

The layer produced in step B) has a thickness between 20 and 4000 μm, preferably between 30 and 3500 μm, especially between 50 and 3000 μm.

If the mixture according to step A) also comprises tricarboxylic acids or tetracarboxylic acids, this achieves branching/crosslinking of the polymer formed. This contributes to an improvement in the mechanical properties.

The polymer layer produced in step C) is treated in the presence of moisture at temperatures and for durations sufficient for the layer to have sufficient strength for use in fuel cells. The treatment can be effected to such an extent that the membrane is self-supporting, such that it can be detached from the support without damage.

In step C), the flat structure obtained in step B) is heated to a temperature of up to 350° C., preferably up to 280° C. and more preferably in the range from 200° C. to 250° C. The inert gases for use in step C) are known in the technical field. These include especially nitrogen and noble gases, such as neon, argon, helium.

In one variant of the process, heating the mixture from step A) to temperatures of up to 350° C., preferably up to 280° C., can already bring about the formation of oligomers and/or polymers. Depending on the temperature and duration selected, it is subsequently possible to partly or entirely dispense with the heating in step C). This variant too forms part of the subject matter of the present invention.

The membrane is treated in step D) at temperatures above 0° C. and less than 150° C., preferably at temperatures between 10° C. and 120° C., especially between room temperature (20° C.) and 90° C., in the presence of moisture or water and/or water vapor and/or water-containing phosphoric acid of up to 85%. The treatment is preferably effected under standard pressure, but can also be effected under pressure. What is essential is that the treatment takes place in the presence of sufficient moisture, as a result of which the polyphosphoric acid present contributes to the consolidation of the membrane by partial hydrolysis to form low molecular weight polyphosphoric acid and/or phosphoric acid.

The hydrolysis liquid may be a solution, in which case the liquid may also comprise suspended and/or dispersed constituents. The viscosity of the hydrolysis liquid may be within wide ranges, and the viscosity can be adjusted by adding solvents or increasing the temperature. The dynamic viscosity is preferably in the range from 0.1 to 10 000 mPa*s, especially 0.2 to 2000 mPa*s, and these values can be measured, for example, to DIN 53015.

The treatment in step D) can be effected by any known method. For example, the membrane obtained in step C) can be immersed into a liquid bath. In addition, the hydrolysis liquid can be sprayed onto the membrane. Moreover, the hydrolysis liquid can be poured over the membrane. The latter methods have the advantage that the concentration of acid in the hydrolysis liquid remains constant during the hydrolysis. However, the first process is frequently less expensive to execute.

### Gas Diffusion Electrodes

In addition to the polymer electrolyte membrane, the inventive membrane electrode assembly further comprises at least one gas diffusion electrode. Typically two electrochemically active electrodes are used (anode and cathode), which are separated by the polymer electrolyte membrane. The term “electrochemically active” indicates that the electrodes are capable of catalyzing the oxidation of hydrogen and/or at least one reformate and the reduction of oxygen. This property can be obtained by coating the electrodes with catalytically active substances such as platinum and/or ruthenium. The term “electrode” means that the material is electrically conductive. The electrode may optionally have a noble metal layer. Such electrodes are known and are described, for example in U.S. Pat. No. 4,191,618, U.S. Pat. No. 4,212,714 and U.S. Pat. No. 4,333,805.

Suitable catalytically active materials are preferably catalytically active metals. These are known to those skilled in the art. Suitable catalytically active metals are generally selected from the group consisting of platinum, palladium, iridium, rhodium, ruthenium and mixtures thereof, more preferably platinum and/or ruthenium. In a very particularly preferred embodiment platinum alone or a mixture of platinum and ruthenium is used. It is also possible to use the polyoxymetallates known to those skilled in the art.

The catalytically active metals or mixtures of different metals used with preference may optionally comprise further alloy additives selected from the group consisting of cobalt, chromium, tungsten, molybdenum, vanadium, iron, copper, nickel, silver, gold, iridium, tin, etc. and mixtures thereof.

In a further preferred embodiment, the at least one catalytically active material has been applied to a suitable support material. Suitable support materials are known to those skilled in the art, for example electron conductors selected from the group consisting of carbon black, graphite, carbon fibers, carbon nanoparticles, carbon foams, carbon nanotubes and mixtures thereof.

In the case of a fuel cell, which is to be operated with a carbon monoxide-comprising reformate gas as fuel, it is advantageous when the anode catalyst has a maximum resistance to poisoning by carbon monoxide. In such a case, preference is given to using electrocatalysts based on platinum/ruthenium.

The gas diffusion electrode for use in accordance with the invention comprises at least one gas diffusion medium and at least one catalyst layer. In the context of a first preferred embodiment of the present invention, these are joined directly to one another. In the context of an alternative preferred embodiment of the present invention, catalyst-coated polymer electrolyte membranes are used, which form the gas diffusion electrode on combination with the gas diffusion medium.

Gas diffusion media are known per se and are described, for example, in U.S. Pat. No. 6,017,650, U.S. Pat. No. 6,379,834 and U.S. Pat. No. 6,165,636. They serve especially for gas distribution, for water management, for current output, for mechanical integrity and for heat conduction.

The gas diffusion media used are typically flat, electrically conductive and acid-resistant structures. These include, for example, graphite fiber papers, carbon fiber papers, graphite fabric and/or papers which have been rendered conductive by addition of carbon black. These layers achieve a fine distribution of the gas and/or liquid streams.

In addition, it is also possible to use gas diffusion media which comprise a mechanically stable support material which has been impregnated with at least one electrically conductive material, e.g. carbon (for example, carbon black), and optionally a binder. It is of course also possible to use other types of electrically conductive particles, for example metal particles, in place of the carbon or in addition thereto.

Support materials particularly suitable for these purposes comprise fibers, for example in the form of nonwovens, papers or fabrics, especially carbon fibers, glass fibers or fibers comprising organic polymers, for example polypropylene, polyester (polyethylene terephthalate), polyphenylene sulfide or polyether ketones. Further details regarding such gas diffusion media can be found, for example, in WO 9720358.

The gas diffusion media preferably have a thickness in the range from 80 μm to 2000 μm, especially in the range from 100 μm to 1000 μm and more preferably in the range from 150 μm to 500 μm.

The gas diffusion media may comprise customary additives. These include surface-active substances.

In a particular embodiment, at least one layer of the gas diffusion media may consist of a compressible material. In the context of the present invention, a compressible material is characterized by the property that the material, without losing its integrity, can be compressed by pressure to half, especially to one third, of its original thicknesses.

This property is generally possessed by gas diffusion layers composed of graphite fabric and/or paper which has been rendered conductive by addition of carbon black.

In the context of the present invention, the gas diffusion medium comprises at least two gas diffusion layers,
the first gas diffusion layer comprising an electrically conductive macroporous layer in which the pores have a mean pore diameter in the range from 10 μm to 30 μm,
the second gas diffusion layer comprising an electrically conductive macroporous layer in which the pores have a mean pore diameter in the range from 10 μm to 30 μm,
the gas diffusion medium comprising polytetrafluoroethylene and
the first gas diffusion layer having a higher polytetrafluoroethylene concentration than the second gas diffusion layer.

These may be two insulated layers. In addition, the layers may also be present in a single medium obtainable, for example, by partial application of polytetrafluoroethylene to one side of the gas diffusion medium.

In a particularly preferred embodiment of the present invention, the gas diffusion medium additionally comprises at least one electrically conductive microporous layer in which the pores have a mean pore diameter in the range from 100 nm to 500 nm.

In a further particularly preferred embodiment of the present invention, the gas diffusion medium does not comprise any such electrically conductive microporous layer.

In this connection, the pore size can be determined by processes known per se. The process of mercury porosimetry has been found to be particularly useful, especially according to the standard DIN 66 133, June 1993.

The arrangement of the gas diffusion layers is in principle as desired. However, a particularly useful structure has been found to be one in which the second gas diffusion layer is arranged between the first gas diffusion layer and the catalyst layer. Another useful structure has also been found to be one in which the first gas diffusion layer is arranged between the second gas diffusion layer and the catalyst layer.

The concentrations of polytetrafluoroethylene in the two gas diffusion layers can in principle be selected freely, provided that the first gas diffusion layer has a higher polytetrafluoroethylene concentration than the second gas diffusion layer.

Preferably, however, the fluorine concentration of the first gas diffusion layer is greater than 0.35 mg/cm², more preferably greater than 0.40 mg/cm², especially greater than 0.5 mg/cm².

The second gas diffusion layer preferably has a fluorine concentration less than 0.30 mg/cm², more preferably less than 0.23 mg/cm², especially less than 0.2 mg/cm².

The ratio of the fluorine concentration in the first gas diffusion layer to the fluorine concentration in the second gas diffusion layer is preferably greater than 1.1:1, favorably greater than 1.5:1, more preferably greater than 2:1, appropriately greater than 4:1, especially greater than 6:1.

The ratio of the fluorine concentration to the carbon concentration in the first gas diffusion layer is preferably at least 0.7, more preferably at least 0.8, especially at least 0.9.

In this connection, the fluorine concentration can be determined in a manner known per se. Particularly useful processes in this connection have been found to be scanning electron microscopy (SEM), electron probe microanalysis (EPMA) and energy-dispersive X-ray spectroscopy (EDXS), especially energy-dispersive X-ray spectroscopy (EDXS) processes, which are described in detail, for example in the publication Ludwig Reimer Scanning Electron Microscopy: Physics of Image Formation and Microanalysis (Springer Series in Optical Sciences), Springer, Berlin; 2nd edition; Sep. 17, 1998.

The first gas diffusion layer preferably comprises a minimum level of carbon black particles, with a particle size less than 100 nm. The first gas diffusion layer preferably comprises more than 30% by weight, appropriately more than 50% by weight, favorably more than 75% by weight, more preferably more than 95% by weight, especially 100% by weight, of polytetrafluoroethylene, based on the total weight of polytetrafluoroethylene and of carbon black particles having a particle size less than 100 nm.

The thicknesses of the first and second gas diffusion layers can in principle be selected freely. However, the thickness of the first gas diffusion layer is preferably greater than 1 μm, more preferably greater than 5 μm, appropriately greater than 10 μm, especially greater than 25 μm. The thickness of the second gas diffusion layer is preferably greater than 1 μm, more preferably greater than 5 μm, appropriately greater than 10 μm, especially greater than 25 μm.

Particularly useful gas diffusion media have additionally been found to be those in which, in cross section, the first gas diffusion layer makes up the first 5% to 30% of the gas diffusion medium, based on the total thickness of the gas diffusion medium.

In this connection, the thicknesses of the gas diffusion layers can be obtained in a manner known per se, especially by means of scanning electron microscopy (SEM).

The catalyst layer(s) comprise(s) catalytically active substances. These include noble metals of the platinum group, i.e. Pt, Pd, Ir, Rh, Os, Ru, or else the noble metals Au and Ag. It is also possible to use alloys of all aforementioned metals. In addition, at least one catalyst layer may comprise alloys of the platinum group elements with base metals, for example Fe, Co, Ni, Cr, Mn, Zr, Ti, Ga, V, etc.

If the gas diffusion electrode according to the present invention is used as an anode in a membrane electrode assembly for direct methanol, hydrogen/air or reformate/air fuel cells it is preferred that the catalysts comprise platinum and/or ruthenium.

If the gas diffusion electrode according to the present invention is used as a cathode in membrane electrode assemblies for direct methanol, hydrogen/air or reformate/air fuel cells it is preferred that the catalysts comprise platinum, platinum-iridium or platinum-rhodium alloys.

The catalytically active particles which comprise the aforementioned substances can be used in the form of metal powder, known as noble metal black, especially in the form of platinum and/or platinum alloys. Such particles generally have a size in the range from 5 nm to 200 nm, preferably in the range from 7 nm to 100 nm.

In addition, the metals can also be used on a support material. This support preferably comprises carbon, which can be used especially in the form of carbon black, graphite or graphitized carbon black. In addition, it is also possible to use electrically conductive metal oxides, for example SnOₓ, TiOₓ, or phosphates, for example FePOₓ, NbPO_{X}, Zr_{y}(POₓ)_{z} as the support material. In these formulae, the indices x, y and z indicate the oxygen or metal content of the individual compounds, which may be within a known range, since the transition metals can assume different oxidation states.

The content of these supported metal particles, based on the total weight of the metal-support compound, is generally in the range from 1% by weight to 80% by weight, preferably 5% by weight to 60% by weight and more preferably 10% by weight to 50% by weight, without any intention that this should impose a restriction. The particle size of the support, especially the size of the carbon particles, is preferably in the range from 20 nm to 1000 nm, especially 30 nm to 100 nm. The size of the metal particles present thereon is preferably in the range from 1 nm to 20 nm, especially 1 nm to 10 nm and more preferably 2 nm to 6 nm.

The sizes of the different particles are averages and can be determined by means of transmission electron microscopy or X-ray powder diffractometry.

The catalytically active particles detailed above can generally be obtained commercially.

In addition, the catalytically active layer may comprise customary additives. These include fluoropolymers, for example polytetrafluoroethylene (PTFE), proton-conducting ionomers and surface-active substances.

In a particular embodiment of the present invention, the weight ratio of fluoropolymer to catalyst material comprising at least one noble metal and optionally one or more support materials, is greater than 0.1, and this ratio is preferably in the range from 0.2 to 0.6.

In a further preferred embodiment of the present invention, it is particularly preferred that the catalyst layer comprises sulfonated polytetrafluoroethylene, and the proportion of sulfonated polytetrafluoroethylene in the catalyst layer is preferably in the range from 10% by weight to 300% by weight, based on the total weight of the catalytically active material. This especially causes an increased oxygen solubility in the cathode, especially at a temperature greater than 100° C.

In addition, the content of unsulfonated polytetrafluoroethylene in the catalyst layer is advantageously less than 30% by weight, favorably less than 10% by weight, more preferably less than 1% by weight, in each case based on the total weight of the catalyst layer.

Furthermore, the content of unsulfonated polytetrafluoroethylene in the catalyst layer is advantageously less than 100% by weight, favorably less than 50% by weight, more preferably less than 1% by weight, based in each case on the total weight of sulfonated polytetrafluoroethylene in the catalyst layer.

In a particularly preferred embodiment of the present invention, the catalyst layer does not comprise any unsulfonated polytetrafluoroethylene.

Moreover, the content of surfactants in the catalyst layer is advantageously less than 30% by weight, favorably less than 10% by weight, more preferably less than 1% by weight, based in each case on the total weight of the catalyst layer.

Furthermore, the content of surfactants in the catalyst layer is advantageously less than 100% by weight, favorably less than 50% by weight, more preferably less than 1% by weight, based in each case on the total weight of sulfonated polytetrafluoroethylene in the catalyst layer.

In a particularly preferred embodiment of the present invention, the catalyst layer does not comprise any surfactants.

The catalyst layer preferably has a thickness in the range from 1 μm to 500 μm, especially in the range from 5 μm to 250 μm, preferably in the range from 10 μm to 150 μm. This value is an average, which can be determined by measuring the layer thickness in the cross section of images which can be obtained with a scanning electron microscope (SEM).

In a particularly preferred embodiment of the present invention, the noble metal content of the catalyst layer is 0.1 mg/cm² to 5.0 mg/cm², preferably 0.3 mg/cm² to 4.0 mg/cm² and more preferably 0.3 mg/cm² to 3.0 mg/cm². These values can be determined by elemental analysis of a flat sample.

For further information about membrane electrode assemblies, reference is made to the technical literature, especially to patent applications WO 01/18894 A2, DE 195 09 748, DE 195 09 749, WO 00/26982, WO 92/15121 and DE 197 57 492 and to the publications W. Vielstich, H. Gasteiger, A. Lamm (editors) Handbook of Fuel Cells—Fundamentals, Technology and Applications, volume 3: Fuel Cell Technology and Applications, chapter 43: Principles of MEA preparation 2003 John Wiley and Sons, Ltd. pages 538-565 and W. Vielstich, H. Gasteiger, A. Lamm (editors) Handbook of Fuel Cells—Fundamentals, Technology and Applications, volume 3: Fuel Cell Technology and Applications, chapter 42: Diffusion media materials and characterisation 2003 John Wiley and Sons, Ltd. pages 538-565. The disclosure in the aforementioned references with regard to the structure and production of membrane electrode assemblies, and the electrodes, gas diffusion layers and catalysts to be selected, is also part of the description.

The inventive membrane electrode assembly can be produced in a manner known per se by combining the elements. Such a membrane electrode assembly is preferably produced by hot pressing. For this purpose, a gas diffusion electrode and a membrane, preferably an ion exchange membrane, especially a proton-conducting membrane, are heated to a temperature in the range from 50° C. to 200° C. and pressed at a pressure in the range from 1 MPa to 10 MPa. A couple of minutes are generally sufficient to bond the catalyst layer to the membrane layer. This time is preferably in the range from 30 seconds to 10 minutes, especially in the range from 30 seconds to 5 minutes.

In a preferred variant, the membrane electrode assembly is obtained by first applying a catalyst layer to the membrane in order first to produce a catalyst-coated membrane (CCM), in order then to laminate the catalyst-coated membrane with a gas diffusion medium on a substrate. The gas diffusion medium to be used has the above-described multilayer structure.

A particularly useful procedure has also been found to be one in which
i.) polytetrafluoroethylene is applied to a gas diffusion medium which comprises an electrically conductive macroporous layer in which the pores have a mean pore diameter in the range from 10 μm to 30 μm,
ii.) the gas diffusion medium from step i) is heat treated at temperatures greater than 100° C.,
iii.) a catalyst material is applied to the gas diffusion medium from step ii).

Thermal treatment is favorably at a temperature less than 280° C., preferably in the range from 40° C. to 250° C., especially in the range from 60° C. to less than 200° C. The duration of the thermal treatment is preferably selected within the range from 1 minute to 2 h.

The catalyst material is preferably applied using a catalyst ink which comprises the catalytically active material and a binder, preferably sulfonated polytetrafluoroethylene. The proportion of sulfonated polytetrafluoroethylene in the binder is preferably in the range from 30% by weight to 300% by weight, based on the total weight of catalytically active material in the catalyst ink. In addition, the content of unsulfonated polytetrafluoroethylene in the binder is advantageously less than 100% by weight, preferably less than 50% by weight, more preferably less than 10% by weight, most preferably less than 1% by weight, especially 0% by weight, based on the total weight of sulfonated polytetrafluoroethylene in the catalyst ink. In addition, the content of surfactants in the binder is advantageously less than 100% by weight, preferably less than 50% by weight, more preferably less than 10% by weight, most preferably less than 1% by weight, especially 0% by weight, based on the total weight of sulfonated polytetrafluoroethylene in the catalyst ink.

The inventive membrane electrode assembly (MEA) is particularly suitable for fuel cell applications, especially for power generation at a temperature greater than 100° C.

It has been found that, surprisingly, inventive single fuel cells, owing to their dimensional stability at varying ambient temperatures and air humidity, can be stored or shipped without any problem. Even after prolonged storage or after shipping to sites with very different climatic conditions, the dimensions of the single fuel cells are correct for problem-free incorporation into fuel cell stacks. The single fuel cell in that case no longer needs to be conditioned on site for external installation, which simplifies the production of the fuel cell and saves time and costs.

An advantage of preferred single fuel cells is that they enable the operation of the fuel cell at temperatures above 120° C. This applies to gaseous and liquid fuels, for example hydrogen-comprising gases, which are prepared, for example, in an upstream reforming step from hydrocarbons. The oxidant used may, for example, be oxygen or air.

A further advantage of preferred single fuel cells is that they have a high tolerance to carbon monoxide in operation above 120° C. even with pure platinum catalysts, i.e. without a further alloy constituent. At temperatures of 160° C. for example, more than 1% CO may be present in the fuel gas without this leading to any noticeable reduction in the performance of the fuel cell.

Preferred single fuel cells can be operated in fuel cells without any need to moisten the fuel gases and the oxidants in spite of the high operating temperatures possible. The fuel cell nevertheless works stably and the membrane does not lose its conductivity. This simplifies the overall fuel cell system and brings additional cost savings since the control of the water circuit is simplified. This additionally also improves the performance at temperatures below 0° C. in the fuel cell system.

Preferred single fuel cells surprisingly allow the fuel cell, without any problem, to be cooled to room temperature and below and then put back into operation, without losing performance. Conventional phosphoric-acid-based fuel cells, in contrast, sometimes have to be kept at a temperature above 40° C. even when the fuel cell system is switched off, in order to avoid irreversible damage.

In addition, the inventive single fuel cells are notable for an improved thermal and corrosion stability and a comparatively low gas permeability especially at high temperatures. A decrease in the mechanical stability and in the structural integrity, especially at high temperatures, is avoided to the best possible degree in accordance with the invention.

Furthermore, the inventive single fuel cells can be produced inexpensively and in a simple manner.

The invention is illustrated in detail hereinafter in examples and comparative examples, without any intention that this should restrict the concept of the invention.

### Production of the Catalyst Ink

2.4 parts of Nafion ionomer in H₂O (10 wt %), equivalent weight 1100 (from DuPont), and 1.85 parts of H₂O were initially charged in a glass bottle and stirred with a magnetic stirrer. Then one part of Pt/C catalyst was weighed in and added gradually to the mixture while stirring. The mixture was stirred with the magnetic stirrer at room temperature for approx. 5-10 minutes. The sample was then treated with ultrasound until the value of the energy introduced was 0.015 KWh. This value was based on a batch size of 20 g.

### Production of Gas Diffusion Electrodes (GDE):

### Starting GDL:

### GDL 1: H2315 1X11 CX45

A Teflon-impregnated gas diffusion layer (GDL) (H2315 1X11 CX45) from Freudenberg with a macroporous layer (mean pore diameter in the range from 10 μm to 30 μm) and a microporous carbon layer (mean pore diameter in the range from 100 nm to 500 nm).

### GDL 2: H2315 1X11

A Teflon-impregnated gas diffusion layer (GDL) (H2315 1X11) from Freudenberg with a macroporous layer (mean pore diameter in the range from 10 μm to 30 μm) without microporous carbon layer (mean pore diameter in the range from 100 nm to 500 nm).

### Comparative Sample 1:

The catalyst-coated gas diffusion electrode (GDE) was produced by printing the catalyst formulation by means of screen printing onto the microporous carbon layer (MPL) of a Teflon-impregnated gas diffusion layer (GDL) (H2315 1X11 CX45) from Freudenberg. The thicknesses and loadings of the GDE are listed in table 1.

### Sample 1:

A Teflon-impregnated GDL with a microporous carbon layer (MPL) from Freudenberg (H2315 1X11 CX45) was coated by spraying of additionally 0.35 mg_{Teflon}/cm² of Teflon onto the reverse side (side facing away from MPL) of the GDL material. This was followed by heat treatment at 340° C. for 2 hours.

The resulting GDL comprised a first macroporous gas diffusion layer (mean pore size in the range from 10 μm to 30 μm) and a second macroporous gas diffusion layer (mean pore size in the range from 10 μm to 30 μm), and the first macroporous gas diffusion layer had a higher polytetrafluoroethylene concentration than the second macroporous gas diffusion layer.

The catalyst-coated gas diffusion electrode (GDE) was subsequently produced by screen printing onto this GDL (MPL side). The thicknesses and loadings of the GDE are listed in table 1.

### Comparative Sample 2:

An attempt was made to print the catalyst formulation onto a Teflon-impregnated GDL (H2315 1X11, no MPL) from Freudenberg by means of screen printing. It was not possible to print this GDL with the catalyst ink.

### Sample 2:

A Teflon-impregnated GDL (H2315 1X11, no MPL) from Freudenberg was coated with additionally 0.29 mg_{Teflon}/cm² of Teflon on the side intended for catalyst application by spraying. The sample was then heat treated at 340° C. for 2 hours.

The resulting GDL comprised a first macroporous gas diffusion layer (mean pore size in the range from 10 μm to 30 μm) and a second macroporous gas diffusion layer (mean pore size in the range from 10 μm to 30 μm), and the first macroporous gas diffusion layer had a higher polytetrafluoroethylene concentration than the second macroporous gas diffusion layer.

The catalyst-coated gas diffusion electrode (GDE) was subsequently produced by screen printing onto this GDL. The thicknesses and loadings of the GDE are listed in table 1.

### Sample 3:

A Teflon-impregnated GDL (H2315 1X11, no MPL) from Freudenberg was coated with additionally 1.45 mg_{Teflon}/cm² of Teflon on the side intended for catalyst application by spraying and then heat treated at 340° C. for 2 hours.

The resulting GDL comprised a first macroporous gas diffusion layer (mean pore size in the range from 10 μm to 30 μm) and a second macroporous gas diffusion layer (mean pore size in the range from 10 μm to 30 μm), and the first macroporous gas diffusion layer had a higher polytetrafluoroethylene concentration than the second macroporous gas diffusion layer.

The catalyst-coated gas diffusion electrode (GDE) was subsequently produced by screen printing onto this GDL. The thicknesses and loadings of the GDE are listed in table 1.

### Sample 4:

A Teflon-impregnated gas diffusion layer (GDL) from Freudenberg (H2315 1X11, no MPL) was coated on each side with 0.4 mg_{Teflon}/cm² of Teflon by spraying and subsequently heat treated at 340° C. for 2 hours.

The resulting GDL comprised a first macroporous gas diffusion layer (mean pore size in the range from 10 μm to 30 μm) and a second macroporous gas diffusion layer (mean pore size in the range from 10 μm to 30 μm), and the first macroporous gas diffusion layer had a higher polytetrafluoroethylene concentration than the second macroporous gas diffusion layer.

The catalyst-coated gas diffusion electrode (GDE) was subsequently produced by screen printing onto this GDL (on one side). The thicknesses and loadings of the GDE are listed in table 1.

TABLE 1
Layer thicknesses and catalyst loadings

| | | Layer | |
|---|---|---|---|
| | | thickness | Cat. loading |
| | GDE | [μm] | [mg_{Pt}/cm²] |
| Comparative | anode | 97 | 1.02 |
| sample 1 | cathode | 99 | 1.03 |
| Comparative | anode | — | — |
| sample 2 | cathode | — | — |
| Sample 1 | anode | 75 | 1.04 |
| | cathode | 79 | 1.05 |
| Sample 2 | anode | 50 | 1.01 |
| | cathode | 51 | 0.99 |
| Sample 3 | anode | 62 | 1.01 |
| | cathode | 66 | 1.03 |
| Sample 4 | anode | 63 | 0.99 |
| | cathode | 65 | 0.98 |

### MEA Production and Cell Testing:

For the cell tests, MEAs (membrane electrode assemblies) were assembled symmetrically from the GDEs thus produced (anode and cathode identical) and Celtec-P membranes. With a spacer, the assembly was pressed to 75% of the starting thickness at 140° C. for 30 seconds. The active area of the MEA was 45 cm². Subsequently, the samples were installed into the cell block and then tested at 160° C., using H₂ (anode stoichiometry 1.2) and air (cathode stoichiometry 2). The performance of the samples at 0.6 A/cm² is compared in table 2.

TABLE 2
Performance of the samples at 0.6 A/cm²

| | P [mW/cm²] at 0.6 A/cm² |
|---|---|
| Comparative sample | 245 |
| 1 | |
| Comparative sample | — |
| 2 | |
| Sample 1 | 313 |
| Sample 2 | 314 |
| Sample 3 | 315 |
| Sample 4 | 314 |

1-17. (canceled)

18. A membrane electrode assembly,
comprising at least one phosphoric acid-containing polymer electrolyte membrane and at least one gas diffusion electrode,
said gas diffusion electrode comprising:
i. at least one catalyst layer and
ii. at least one gas diffusion medium having at least two gas diffusion layers,
the first gas diffusion layer comprising an electrically conductive macroporous layer in which the pores have a mean pore diameter in the range from 10 μm to 30 μm,
the second gas diffusion layer comprising an electrically conductive macroporous layer in which the pores have a mean pore diameter in the range from 10 μm to 30 μM,
the gas diffusion medium comprising polytetrafluoroethylene,
wherein
the first gas diffusion layer has a higher polytetrafluoroethylene concentration than the second gas diffusion layer.

19. The membrane electrode assembly according to claim 18, wherein the second gas diffusion layer is arranged between the first gas diffusion layer and the catalyst layer.

20. The membrane electrode assembly according to claim 18, wherein the first gas diffusion layer is arranged between the second gas diffusion layer and the catalyst layer.

21. The membrane electrode assembly according to claim 18, wherein the first gas diffusion layer has a thickness greater than 1 μm.

22. The membrane electrode assembly according to claim 18, wherein the first gas diffusion layer has a fluorine concentration greater than 0.35 mg/cm².

23. The membrane electrode assembly according to claim 18, wherein the second gas diffusion layer has a fluorine concentration less than 0.30 mg/cm².

24. The membrane electrode assembly according to claim 18, wherein the ratio of the fluorine concentration in the first gas diffusion layer to the fluorine concentration in the second gas diffusion layer is greater than 1.1:1.

25. The membrane electrode assembly according to claim 18, wherein the first gas diffusion layer comprises more than 30% by weight of polytetrafluoroethylene, based on the total weight of polytetrafluoroethylene and of carbon black particles having a particle size less than 100 nm.

26. The membrane electrode assembly according to claim 18, wherein, in cross section, the first gas diffusion layer makes up the first 5% to 30% of the gas diffusion medium, based on the total thickness of the gas diffusion medium.

27. The membrane electrode assembly according to claim 18, wherein the catalyst layer comprises sulfonated polytetrafluoroethylene.

28. The membrane electrode assembly according to claim 27, wherein the content of sulfonated polytetrafluoroethylene in the catalyst layer is in the range from 10% by weight to 300% by weight, based on the total weight of the catalytically active material.

29. The membrane electrode assembly according to claim 18, wherein the content of unsulfonated polytetrafluoroethylene in the catalyst layer is less than 100% by weight, based on the total weight of sulfonated polytetrafluoroethylene in the catalyst layer.

30. The membrane electrode assembly according to claim 18, which comprises at least one polyazole.

31. The membrane electrode assembly according to claim 30, wherein the polyazole comprises repeat azole units of the general formula (I) and/or (II) and/or (III) and/or (IV) 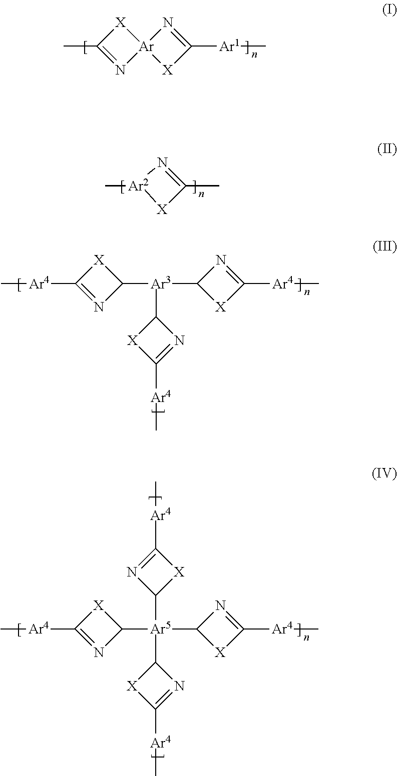
in which
Ar is the same or different and is a tetravalent aromatic or heteroaromatic group, which may be mono- or polycyclic,
Ar¹ is the same or different and is a divalent aromatic or heteroaromatic group, which may be mono- or polycyclic,
Ar² is the same or different and is a di- or trivalent aromatic or heteroaromatic group, which may be mono- or polycyclic,
Ar³ is the same or different and is a trivalent aromatic or heteroaromatic group, which may be mono- or polycyclic,
Ar⁴ is the same or different and is a trivalent aromatic or heteroaromatic group, which may be mono- or polycyclic,
X is the same or different and is oxygen, sulfur or an amino group, which bears a hydrogen atom, a group having 1 to 20 carbon atoms, and
n is an integer greater than or equal to 10.

32. The membrane electrode assembly according to claim 31, wherein
X is the same or different and is oxygen, sulfur or an amino group, which bears a hydrogen atom, a group having 1 to 20 carbon atoms. a branched or unbranched alkyl or alkoxy group, or an aryl group as a further radical and
n is an integer greater than or equal to 100.

33. A process for producing a membrane electrode assembly according to claim 18, which comprises
i.) applying polytetrafluoroethylene to a gas diffusion medium which comprises an electrically conductive macroporous layer in which the pores have a mean pore diameter in the range from 10 μm to 30 μm,
ii.) heat treating the gas diffusion medium from step i) at temperatures greater than 100° C.,
iii.) applying a catalyst material to the gas diffusion medium from step ii).

34. A fuel cell comprising at least one membrane electrode assembly according to claim 18.

35. A process for power generation at a temperature greater than 100° C. which comprises utilizing the fuel cell according to claim 33.
